(19) United States
(12) Patent Application Publication
(10) Pub. No.: US 2008/0217489 A1
(43) Pub. Date: Sep. 11, 2008

(54) Tube supporting system

(75) Inventor: Leonard Richard Higbee, Chorelywood (GB)

Correspondence Address: Davidson, Davidson & Kappel, LLC, 485 7th Avenue, 14th Floor, New York, NY, 10018, US

(73) Assignee: Davy Process Technology Limited, London (GB)

(21) Appl. No.: 11/904,329

(22) Filed: Sep. 26, 2007

Related U.S. Application Data
(63) Continuation of application No. 10/472,099, filed on Feb. 12, 2004, now abandoned.

(30) Foreign Application Priority Data
Mar. 14, 2001 (GB) 0106308.0

(51) Int. Cl. F28F 9/013; F16L 3/22

(52) U.S. Cl. 248/68.1; 165/162

(57) ABSTRACT

A tube supporting device is described which in a preferred embodiment comprises ferrules (1) located on the tubes (2), brace means (3) connecting the ferrules (1) and cleats (7) connecting rows of tubes (2). The brace means (3) may be held in position by means of a retaining band (8) which itself is located in position by a stave (9). The support structure is capable of being assembled as the tube bundle is assembled.

### FIELD OF THE INVENTION

The present invention relates to a tube support device. More particularly the present invention relates to a device for supporting the tubes of a tube bundle, particularly where the support structure is built up as the tube bundle is constructed.

### BACKGROUND OF THE INVENTION

Heat exchange between fluids is often carried out within a vessel known as a shell which contains a plurality of tubes. In such arrangements, one fluid flows within the tubes and the other flows within the shell such that heat exchange occurs across the walls of the tubes. The tubes are conventionally arranged as tube bundles held by a tube sheet or between tube sheets. Tube bundles are generally efficient heat exchangers as they enable a large surface area of heat exchange surface to be exposed to the fluids.

These tube bundles are used in a variety of devices including simple heat exchangers where the only function of the device is to allow for the transfer of heat between the separated fluids. Alternatively, the devices may be reactors in which chemical reactions may be carried out either within the tubes themselves or in the shell. Here heat exchange may be required to remove the heat of reaction from the reactor or to provide the heat required to promote the reaction.

There is a necessity that the tubes within the tube bundle are supported. Support may be required for a number of reasons. In particular, it may be required to protect the tubes from damage during normal operation and during transportation from the fabrication site to the operating site. The damage suffered may include metal fatigue resulting from vibration movement or erosion arising from repeated tube collisions. The tubes may even buckle. These problems are particularly acute where any reaction occurring within the shell or tubes exposes the tubes to strong mixing and/or vibrating forces coupled with thermally induced stresses.

A further problem which may arise, for example where the tube bundles are used in conventional or fluidized bed steam generators, is that particles and soot may accumulate around any support arrangement. This accumulation of soot not only reduces the heat exchange capability of the tubes but may also lead to the tubes becoming corroded.

Any system used to address the above-mentioned problems must also deal with further difficulties which often arise due to the variation in thermal expansion that can occur between the tubes and between the tubes and the shell of the exchanger. This differential in expansion means that rigid fastening of the tubes may be disadvantageous.

Various support devices for tube bundles have been proposed. Commonly, tube support is provided by one or more plates which lie in a plane perpendicular to the longitudinal direction of the tubes. The plate or plates, in addition to supporting the tubes, also act as baffles which divert the fluid flow within the shell of the exchanger such that a side to side flow pattern across the tube bundle is achieved. The use of such baffles and tube supports is described in “Standards of the Tubular Exchanger Manufacturers Association” (TEMA) and Perry's Chemical Engineers' Handbook which is published by McGraw-Hill.

Whilst properly designed plates may provide sufficient tubular support in certain circumstances the presence of the plates can be disadvantageous particularly in arrangements where a shellside flow substantially parallel to the tubes is required either in normal operation or during catalyst loading, cleaning and the like. Examples of these arrangements include systems in which liquids are boiling in the shell. The disadvantage for a boiling liquid in the shell arises because the shell is often arranged vertically to allow a thermosyphon to operate and hence vapour flow parallel to the tubes is required.

Tubes may also be used in reactor systems in which the direction of flow within the shell is across, ie perpendicular to, the tubes. Examples of these reactors, which are known as cross-flow reactors can be found in U.S. Pat. No. 4,321,234 and U.S. Pat. No. 5,520,891. The tube support devices used in such reactors must not substantially restrict gas flow in normal operation and support the tubes during transportation.

Whether flow within the reactor shell is parallel or perpendicular to the tubes, the presence of the plates may also be disadvantageous where the shell is to be packed with catalyst. This is because the plates or alternative supporting device may disrupt the flow of catalyst into the shell such that areas in the shadow of the plates may have little or no catalys. The presence of zones having little or no catalyst not only decreases the volume of catalyst that can be loaded into the reactor, but also provides undesirable low pressure flow paths for the reacants through the shell, such that contact between the catalyst and the reactants is reduced. The reduced volume of catalyst and ineffective flow paths decrease the quantity of reaction that is achieved in the device.

Various alternative methods of tube support have been suggested. In U.S. Pat. No. 4,589,618 a holding device for a tube bundle is described which comprises pairs of undulated metal strips which are located on either side of a row of tubes in contraposition such that the tubes are located in the apertures formed between the strips and a clamp may be secured between the strips where they come together between the tubes.

In U.S. Pat. No. 4,871,016 an arrangement is described in which the tubes of the tube bundle are supported by a plurality of rods arranged at a substantial angle to the fluid flow. Thus the rods pass through the spaces on either side of the tubes such that the rods are in direct contact with the tubes and essentially bridge the space between the tubes.

In U.S. Pat. No. 4,848,452 a support device is provided in which a pair of brackets disposed around a vertical tube are used to support horizontal tubes extending horizontally in a conventional or fluidized bed steam generator. Each support bracket has a central sleeve with a pair of opposite extending tube hooks that taper in width from the sleeve outwardly to the end of the hook.

In FR 2325009 a support design for use with straight tubes is described which comprises a plurality of wide bands extending from a rod between adjacent rows of tubes. This arrangement would significantly impede flow if used in a cross-flow reactor and would further restrict catalyst loading.

An alternative arrangement is described in U.S. Pat. No. 5,213,155 in which a U-shaped stake locks a single row of transversely extending parallel tubes.

In practice, the tubes are often not straight along their entire length. For example, they may be bent at their ends to allow connection to suitable connector headers such as in U.S. Pat. No. 4,321,234 and U.S. Pat. No. 5,520,891 or within the body of the shell, such as is illustrated in U.S. Pat. No. 2,538,305.

Many of the prior art arrangements incorporate plates or, for example, as in NL 7906572, grids. In practice, these plates or grids are preformed and then slid down the tube bundle to the desired location. It will be understood that such arrangements cannot be utilised with bent tubes.

Whilst the support device of U.S. Pat. No. 2,538,305 is adapted for use with bent tubes, the catenary plates required would restrict loading of catalyst into the shell and is therefore not desirable in such reactors.

Whilst the above arrangements go some way to solving some of the problems associated with the use of tube bundles, there is still a need for a tube support device which successfully addresses all of these problems and which is cost effective to produce and which can be readily assembled even with bent tubes. Thus there is a requirement for a tube support device which meets these criteria and which is suitable for use where interruption of the flow parallel or perpendicular to the tubes must be minimised but which provides support in all directions in the plane perpendicular to the tubes and which does not impede the introduction of any catalyst to be used.

### SUMMARY OF THE INVENTION

A system has now been designed which addresses the problems of the prior art devices, and for which the parts are simple to manufacture and the whole is simple to assemble. Thus according to a first aspect of the present invention, there is provided a tube support structure for a plurality of tubes forming a tube bundle in a heat exchanger comprising at least one ferrule located on each tube of the bundle and at least one brace means connecting ferrules on different tubes wherein said support structure is capable of being assembled as the tube bundle is assembled.

Thus the support system of the present invention provides a simple but effective means of supporting the tubes of a heat exchanger and which does not impede flow within the reactor shell whether parallel to, or perpendicular to, the tubes, does not impede catalyst loading, which can be assembled in layers with the tube bundle such that bent tubes can be accommodated and which when assembled is sufficiently rigid to withstand the forces imposed during lifting, transportation and in service.

The ferrules are preferably a close fit to the tubes and therefore will be of approximately the same internal diameter as the external diameter of the tubes. In a most preferred arrangement, the ferrules, whilst being a close fit are a sliding fit on the tube. A particular advantage of this embodiment of the present invention is that the ferrules may be placed on the tubes prior to final forming and, if required, subsequently moved to their desired position. This is advantageous where the final forming would make it difficult, or even impossible to fit the ferrules after forming. One example of this is where the tubes are to be bent or otherwise shaped during final forming.

The ferrules may be of any suitable length. The length of the ferrule selected may be dependent on the size of the tube to be supported but is preferably less than 100 mm (4 inches) and more preferably in the region of 15 mm to 30 mm, and most preferably 25 mm (1 inch) long. The ferrules may be made from any suitable material. The selection of a suitable material may depend on the fluids present in the shell or the products and by-products of any reaction in the shell.

In a most preferred arrangement, each tube will have a number of ferrules spaced along its length. Ferrules which align in a suitable manner on different tubes are preferably connected by a plurality of bracing means. By this means, the tubes will be supported in various positions along their length.

The or each brace means is preferably a rod. It will be appreciated that the at least one rod may be formed of any suitable cross-sectional shape and size. Since the size of the rod selected for use will preferably depend on the level of support required, the size of the rod will generally depend on the diameter of the tubes which have to be supported, on their spacing within the bundle or on both the diameter of tubes and their spacing within the bundle.

The tubes preferably have a diameter of from 15 to 80 mm. The spacing of the tubes is preferably in the range of 1.15 to 3 times the tube diameter, more preferably 1.3 to 3 times the tube diameter. In a preferred arrangement, the at least one rod is of circular cross-section and has a diameter which is in the range of 0.05 to 0.75 times the tube spacing, more preferably in the range of 0.10 to 0.33 times the tube spacing.

However, the tube size and spacing is generally a function of the heat transfer surface required and is not dictated by the design of the tube support system which has to accommodate the heat transfer requirement.

Whilst the size of the rod selected will normally depend on the size of the tubes and/or their spacing, other factors may also need to be taken into account, including whether there will be high vibrational forces in the shell.

The rods may be of a cross-sectional size which would normally be described as a wire. However, for ease of reference the term “rod” will be used throughout and it will be understood that this term includes wires.

In one alternative arrangement, the brace means will be a bar. The bar will preferably have a width to height ratio for the cross-sectional dimensions of the bar of 5:1 or less. Most preferably the width to height ratio is 1.5:1 or less.

Whilst the use of rods is preferred, it will be understood that any suitable structure may be used. An example of an alternative structure is a mesh having apertures of a suitable configuration including rectangular, pentagonal, hexagonal and the like. The thickness of the mesh and the size of the apertures will be selected to provide the required support. Further, the size of the apertures is preferably selected such that the flow of solid particles, where present, is not restricted.

The ferrules are preferably located colinearly in the bundle and are connected by bracing means which are positioned across adjacent tubes and which connect the ferrules to restrict preferably prevent, movement within the plane of the bracing means and/or prevent the tubes from moving out of the plane.

The tubes within each bundle are preferably located in rows and thus the preferred arrangement of locating the bracing means across adjacent tubes will prevent movement of the tubes within the row and/or out of the plane of each row of tubes.

Where more than one ferrule is present on each tube and these are arranged such that the bracing means can be placed in a perpendicular arrangement to the tubes, the ferrules may be spaced in any appropriate spacing to provide the level of rigidity required in the support

The spacing is preferably not greater than the recommendations for the maximum unsupported straight tube span made by the Tubular Exchanger Manufacturers Association, the standard of which is incorporated herein by reference.

Any suitable spacing for the ferrules may be used. The ferrules on a tube may preferably be spaced at from about 150 mm (6 inches) to about 2.5 m (90 inches), preferably from about 300 mm (12 inches) to about 2 m (72 inches), spacing such as 900 mm (36 inches), 450 mm (18 inches) or 600 mm (24 inches).

However, alternative arrangements may be used, for example, the ferrules may be positioned in any suitable arrangement on the tubes which enables them to be connected by the brace means whether it be rods, a mesh or other arrangement.

As a tube bundle may be formed from a plurality of rows of tubes, in which each row will include the brace means described above, the support structure may additionally include means for securing the rows of tubes such that movement of the rows relative to one another is restricted and preferably prevented.

The means for securing the rows of tubes is preferably a cleat which extends from one row of tubes and is connected to at least one adjacent row of tubes.

In a preferred arrangement, the cleat may extend from a ferrule in a first row to a brace means in an adjacent row. The cleat may be attached to the ferrule by any suitable means, such as welding and the like. The cleat may be attached to the support structure in the adjacent row by any suitable means. Where the support structure includes one or more rods or a mesh, the cleat may be welded to the rod or mesh or may be a snap-fit with the brace means.

In one alternative arrangement, the cleat may extend from a ferrule in a first row to a ferrule in an adjacent row.

In a second alternative arrangement, the cleat may extend from a brace means in a first row to a brace means in a second row.

In a third alternative arrangement, the cleat may allow more than two adjacent rows to be connected. For example, the cleat may extend from a ferrule in a first row, have means to interconnect with a brace in a second row and extend on to a ferrule on a third row.

Whilst reference has been made to the cleat interconnecting adjacent rows, it will be understood that the cleat may connect rows which are not adjacent. Thus, for example, a cleat may extend from a first to a third row without interconnecting with a second. This will particularly be the case where the brace means in the second row does not coincide in position with that in the first and third rows.

However arranged, the support structure will preferably comprise sufficient cleats to hold rows of tubes in position. Thus sufficient cleats will be present in the support system to restrict, preferably prevent movement of the tubes out of the plane of the rows. Thus, it is generally unnecessary to include a cleat for each ferrule.

The cleat may be of any suitable shape. The shape selected will depend to a large extent on how it is to be connected within the support structure. It is preferably made from plate or bar.

The rows of tubes, when assembled in the bundle, may be arranged in any suitable configuration. Where the rows are arranged such that the tubes in adjacent rows are arranged on a triangular pitch the spacing of the tubes is preferably in the range of 1.3 to 3 times the tube diameter. Where the rows are arranged such that the tubes in adjacent rows are arranged on a square pitch the spacing of the tubes is preferably 1.15 to 3 times the tube diameter.

In a preferred arrangement, the support system includes at least one retaining means substantially extending around the exterior of the tube bundle and which interconnects with the brace means. The use of the retaining means is particularly useful where the brace means are rods or bars. The retaining means will hold the bracing means and the attached ferrules in position.

The or each retaining means is preferably a band extending around the periphery of the bundle. Where the bundle is of a circular cross-section, the band will preferably be a retaining ring. The ends of the brace means will be preferably attached to the band by any suitable means, most preferably welding. The band may be assembled from a series of segments joined together. Where more than one retaining means is present, the support structure will preferably include at least one spacing stave which extends parallel to the tubes and to which the or each retaining means is connected. The or each stave therefore serves to hold the or each retaining means, and hence the bracing means attached to the retaining means, in position.

In one alternative arrangement, the stave may be located within the bundle.

In a second alternative arrangement, the or each brace means is attached directly to a stave and the retaining means may be omitted. In this arrangement, the stave may be located within the bundle.

In a third arrangement, the bracing means is a mesh, which extends substantially along the entire length of the tubes. In this arrangement the retaining means and/or the stave may not be required.

The various components of the support structure may be constructed from the same or different materials and in one arrangement will be constructed from the same materials as those used for the shell and/tubes of the heat exchanger.

In one alternative arrangement the elements may be constructed of a material having a higher tensile strength than that used for the other parts of the heat exchanger which will enable, for example smaller cross-sectional brace means to be used than would otherwise have been possible.

Whichever material is used it is important that it is compatible with the fluids in the shell of the heat exchanger.

Thus it will be understood that one advantage of the support structure of the present invention is that no special materials are necessary for the various components and that no casting, machining or forming of complex parts is required.

The arrangement of the present invention will provide adequate tube support in all directions within the heat exchanger while allowing longitudinal expansion or contraction of the tubes relative to the support. The tube support structure will prevent any damage or distortion of the tubes which might arise during normal operation and further provides support during the transportation of the device in a horizontal orientation where the heat exchanger is constructed at a site remote from the site of use.

Further, the support provides essentially uniform distribution of cross-sectional area available in the plane perpendicular to the longitudinal direction of the tubes and avoids variation of the distribution of this area which can arise from the expansion of the tubes within the shell and differential expansion between tubes due to temperature differences between the tubes and the shell.

The support structure of the present invention also minimises the restriction to longitudinal flow in the shell. The restriction to flow is minimised for both fluid used for heat exchange in the shell-side of the exchanger and the flow of solid particles, for example of catalyst or absorbent. The arrangement allows any particles used to fill the shell to be evenly distributed within the shell side of the device by gravity, or by hydraulic or pneumatic distribution.

A further benefit of the present invention is that the tube support structure does not provide any significant resistance to cross or radial flow within the shell through the tube bundle.

A further advantage of the invention is that the assembly of tube supports can be used in situations where the design of the tubes prevents the use of a plate or other horizontally coherent devices for example where the geometry of the tubes prevents the passage of the plate or the like along the tube bundle during the assembly of the device. This can occur for example where the diameter of the tube plate is less than the principle diameter of the tube bundle or where the tubes are bent outside the normal operating zone.

A further benefit is that the support structure enables the tube bundle to be readily constructed such that the support structure is assembled during the assembly of the tube bundle and thereby serves to hold the tubes in position during assembly.

In general, the tube bundle would be constructed in a row by row progression. Thus in a preferred embodiment, a row of tubes will be assembled with their associated ferrules and connected via the brace means. A second row would be produced in like manner and then laid adjacent to the first row and connected by sufficient cleats to hold the second row in position. This procedure will be repeated for each row. Where required, the bracing means may be assembled as a grid or mesh prior to installation. Where a retaining means is used, this may be placed around the bundle after it has been constructed. Alternatively, where the retaining means is a band formed from segments, it will be constructed in parts as the bundle is constructed. In one arrangement, the retaining band may be welded to ferules in the outermost layer of the bundle in addition to the ends of the rods at the side of the bundle.

According to a second aspect of the present invention there is provided a tube bundle comprising a plurality of tubes and the tube support structure of the above first aspect of the present invention.

According to a third aspect of the present invention there is provided a heat exchanger comprising a shell and at least one tube bundle of the above second aspect of the present invention.

According to a fourth aspect of the present invention there is provided a reactor comprising a shell and at least one tube bundle of the above second aspect of the present invention.

The reactor is preferably a cross-flow reactor, which most preferably includes a catalyst.

According to a fifth aspect of the present invention there is provided a kit of parts for forming the tube support structure of the above first aspect of the present invention optionally with instructions for assembly.

### BRIEF DESCRIPTION OF THE DRAWINGS

The present invention will now be described, by way of example, with reference to the accompanying drawings in which:

FIG. 1 is a perspective view (not to scale) of part of a row of tubes supported in accordance with the present invention;

FIGS. 2a to 2d are schematic diagrams of alternative arrangements for attaching the bracing means to the ferrules;

FIG. 3 is a perspective view (not to scale) of two adjacent rows of tubes connected in accordance with a preferred embodiment of the present invention;

FIG. 4 is an end view of one arrangement of the present invention;

FIG. 5 is a view along line A-A of FIG. 4;

FIG. 6 is a schematic diagram of part of a tube bundle with a portion of the support structure;

FIG. 7 is the schematic diagram of part of the support structure; and

FIG. 8 is a simplified means of part of a cross-section of a bundle with tube support For clarity a number of tubes have been omitted.

### DETAILED DESCRIPTION OF THE INVENTION

It will be understood by those skilled in the art that the drawings are diagrammatic and that further items of equipment such as inlets, outlets, flow controllers and the like may be required in a commercial plant. Provision of such ancillary equipment forms no part of the present invention and is in accordance with conventional chemical engineering practice.

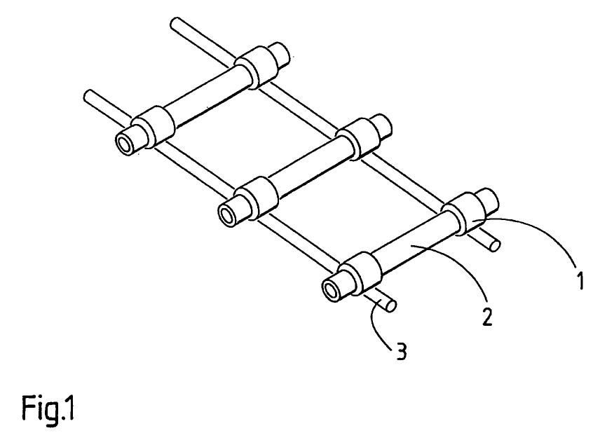

As illustrated in FIG. 1, the support system of the present invention comprises ferrules 1 which are a close but sliding fit on tubes 2. The ferrules are connected by bracing means which in the embodiment of FIG. 1 comprise rods 3 which connect ferrules situated on corresponding positions on adjacent tubes such that the connecting rods are perpendicular to the tubes. Whilst the adjacent rods are shown as being located on the same side of the rods, it will be understood that they could be located on opposing sides of the tubes where this is advantageous, for example with regard to fluid flow paths within the shell.

Whilst the arrangement of FIG. 1 illustrates 3 tubes, 2 ferrules on each tube and two rods connecting the ferrules, this is for illustration purposes only and the tubes, which may be of any length and be present in any number, will be supported by the number of ferrules and braces required to provided the appropriate level of support.

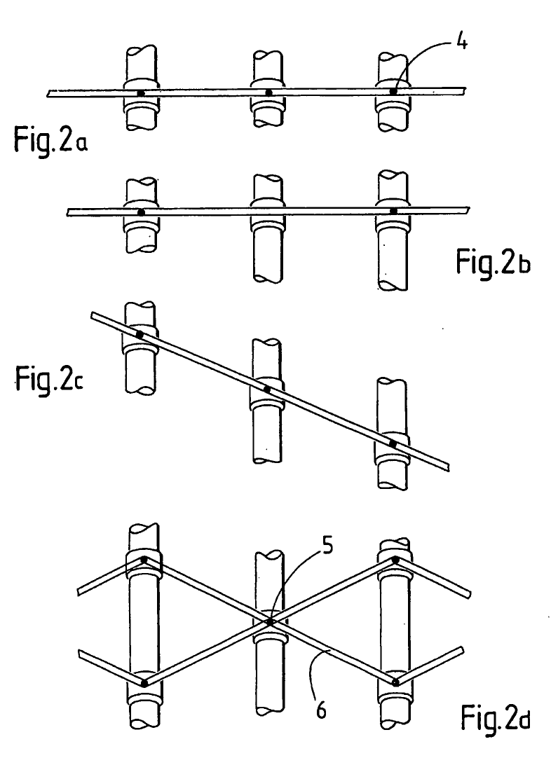

As illustrated schematically in FIG. 2a, the bracing rods 3 may be connected, preferably by welding to each ferrule at point 4. In one alternative arrangement, the rod may not be attached to every ferrule in its path (FIG. 2b). However normally, if the rod is not to be attached to a particular tube via a ferrule, that ferrule will be omitted.

FIG. 2c illustrates a further alternative arrangement. In this arrangement, the ferrules on adjacent tubes do not align such that the bracing rod 3 can be positioned in perpendicular arrangement to the tubes. In this arrangement, the rod is in a diagonal configuration.

Where a mesh is used for the bracing means, the ferrules will be located on the tubes to coincide with points on the mesh. An example of this arrangement is illustrated in FIG. 2d. Although in the illustrated arrangement, the attachment of the ferrules to the mesh is at the joints in the mesh, it will be understood that they could equally be along arms 6 of the mesh.

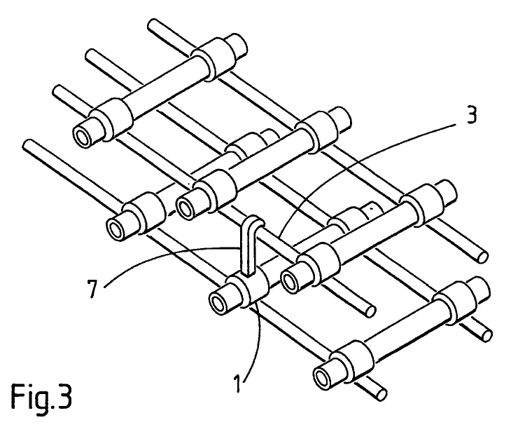

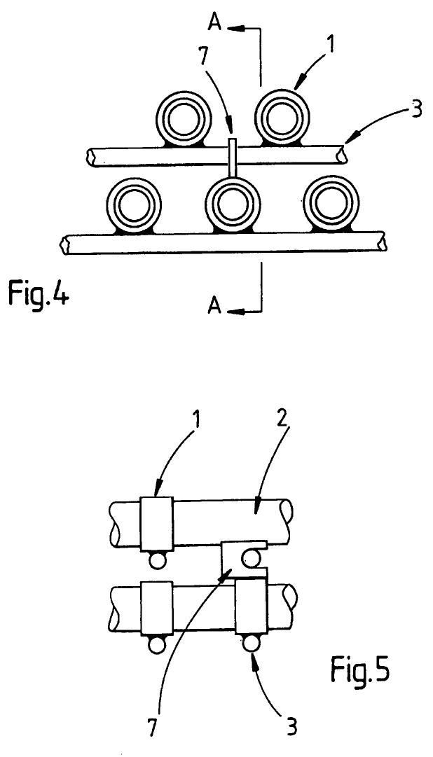

Rows of tubes connected via ferrules and braces are placed together as illustrated in FIG. 3. The rows of supported tubes may be located such that the bracing rods are facing each other between two rows and the ferrules face each other on subsequent parts of rows. However, the embodiment illustrated in FIG. 3 is preferred.

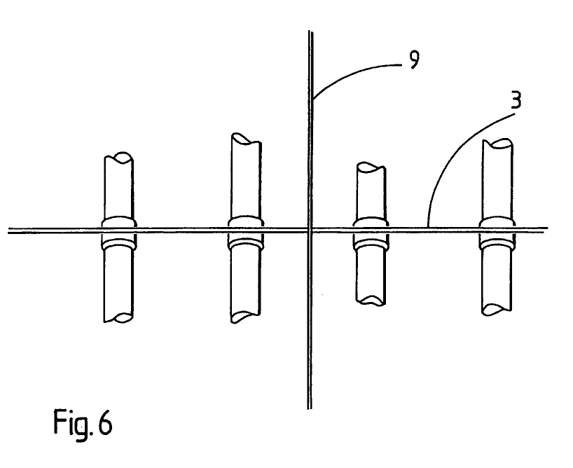

As illustrated more clearly, the arrangement of FIG. 3 has the tubes arranged in triangular pitch. The rows are held together by the presence of cleat 7 which extends from a ferrule 1 in a first row to the rod 3 of a second row. The cleat 7 is welded to both ferrule 1 and to rod 3. As illustrated in the side view in FIG. 5, the cleat is of a generally “C” configuration.

As illustrated in FIG. 6, a stave 9 may be included within the tube bundle to which the bracing rods 3 are attached. This will hold the bracing rods and the ferrules attached thereto at their relative positions along the tubes.

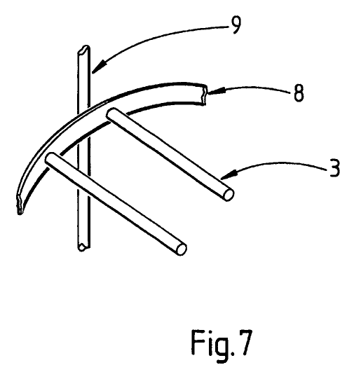

Whilst the stave may be located within the bundle, a preferred arrangement of part of the support is illustrated in FIG. 7. Here, the rods 3 are connected at their ends to a retaining band 8. This will normally be circular and made up of a number of segments bonded together. The ends of the rods 3 will normally be welded to the band 8.

In use there will normally be a number of layers of rods supporting the tubes at various positions along their length. A band 8 is provided for each layer of rods. The bands will be held in place by stave 9.

In use within a heat exchanger, the rows of tubes 1 connected via rods 3 and held in place by cleats 7, retaining bands 8 and stave 9 allow the tube bundle to be held with sufficient rigidity and stability. However, as the support rods are of a diameter less than the spacing between the tubes minimal resistance to flow in any direction is achieved.

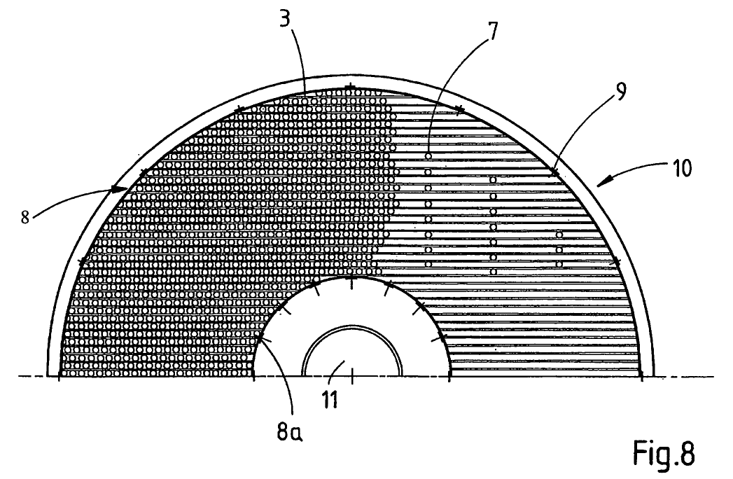

As illustrated in FIG. 8, a tube bundle for a heat exchanger 10 having a central inlet pipe 11 includes a tube bundle having an annular cross section. In construction, the rods 3 are welded in row by row as the tube bundle is built. The end of each rod 3 is welded to the support band 8 formed from segments. Staves 9 are included to hold the bands in position.

For an annular construction, an inner retaining band 8a will also be present and to which rods will be welded. Inner staves may also be included.

The top and bottoms of the tubes may be connected to tube sheets according to conventional means.

The construction and operation of the present supported tube bundle will now be discussed with reference to Example 1.

### EXAMPLE 1

A tube bundle in a reactor shell of a catalytic reactor having radial gas flow from a central inlet pipe is constructed. The tube bundle contains tubes of 31.25 mm (1.25 inch) Nominal bore on a 75 mm (3 inch) triangular pitch. Ferrules are placed on each tube so that they are spaced out evenly at a 900 mm (36 inch) spacing along the tubes. The ferrules are cut from 37.5 mm (1.5 inch) Schedule 10 stainless steel pipe and are 25 mm (1 inch) wide.

A series of grids of 12.5 mm (0.5 inch) diameter rods is constructed to match the width of each row of tubes at a 450 mm (18 inch) spacing of the rods. The length of the bracing rods which will lie across the tubes exceeds the width of the next row of tubes by 50 mm (2 inches) and hence allows for their later attachment to a retaining ring. The total length of the spacing staves is 50 mm (2 inches) less than the distance between the tube plates, to allow for differential expansion between the tubes and the shell. The staves are also placed at 900 mm (36 inch) spacing where the tube row width exceeds this distance.

The construction of the tube bundle and the support structure is continued in accordance with the following procedures. A row of tubes is inserted into the first tube sheet. A support grid of rods lying across the tubes and staves lying parallel with the tubes is placed in front of the tube row. The ferrules on the inserted tubes are attached to the grid at the points of intersection by tack welding. The rods and staves are also welded at points of intersection.

A second row of tubes is then inserted into the tube sheet. Cleats made from 6.25 mm (0.25 inch) thick strip are cut to fit the space between the ferrules and the tube rows behind and are rebated to fit over the bracing rods. The cleats are placed over the bracing rods behind the new row of tubes at 450 mm (18 inch) spacing. The cleats are tack welded to the appropriate ferrules of the newly installed row of tubes.

A new support grid is placed across the tubes as before and the ferrules on the second row of tubes are attached by tack welding to the second grid. The procedure will continue until all tube rows are installed. Retaining rings are attached around the tube bundle and connected to the end of the bracing rods. The rings are made of 6.25 mm (0.25 inch) rod and are tack welded to the side of the protruding ends of the bracing rods. A similar set of support rings are also provided around a 1.5 metres (5 feet) diameter space without tubes in the centre of the tube bundle where the inlet distributor for the radial distribution of the gas flowing through the shell is installed.

By these means a tube bundle is constructed in which a regular spacing between the tubes can be maintained during operation, initial transportation and during catalyst loading into the shell holding the tube bundle.

The catalyst to be used in this arrangement is of a 6.25 mm (0.25 inch) dimension, so that it is easily able to pass down between the tubes and around the support grid, when introduced from above into the vertical tube bundle. On inspection it is noted that there is no uneven distribution of the catalyst or the cooling surfaces of the tubes caused by lateral displacement of the tubes from their intended position. Further the disturbance caused by the tube support grid to the ideal radial flow of gas through the tube bundle, when in process operation, is negligible compared with the disturbance caused by the tubes and the effect of the catalyst.

1. A tube support structure for a plurality of tubes forming a tube bundle in a heat exchanger comprising at least one ferrule located on each tube of the bundle and at least one brace means connecting ferrules on different tubes wherein said at least one brace means is a sliding fit on said tube and wherein said support structure is capable of being assembled as the tube bundle is assembled.

2. A tube support structure according to claim 1, wherein each tube has a number of ferrules spaced along its length and a plurality of brace means is used to connect the ferrules.

3. A tube support structure according to claim 1, wherein each ferrule on each tube is located collinearly in the bundle and is connected by the bracing means positioned across adjacent tubes such that movement within the plane of the bracing means is restricted.

4. A tube support structure according to claim 1 wherein the tubes are located in rows and the bracing means are positioned across adjacent tubes such that movement within the plane of the row of tubes is restricted.

5. A tube support structure according to claim 1 wherein each ferrule has a length of less than 100 mm (4 inches).

6. A tube support structure according to claim 1 wherein a plurality of ferrules are present on each tube and are spaced at from 150 mm (6 inches) to 1200 mm (48 inches) apart.

7. A tube support structure according to claim 6 wherein the ferrules on each tube are spaced at 405 mm (18 inches) apart.

8. A tube support structure according to claim 1 wherein each brace means comprises a rod, bar or mesh.

9. A tube support structure according to claim 8 wherein the bar has width to height dimensions in a ratio of 5:1 or less.

10. A tube support structure according to claim 1 wherein the tubes are located in rows and the support structure additionally includes means for connecting the rows of tubes to restrict relative movement of the rows.

11. A tube support structure according to claim 10 wherein the means for connecting the rows of tubes is at least one cleat extending from one row to a subsequent row.

12. A tube support structure according to claim 11 wherein the cleat extends from one row to an adjacent row.

13. A tube support structure according to claim 11 wherein the cleat extends from a ferrule in a first row to a brace means in an adjacent row.

14. A tube support structure according to claim 1 wherein the tube bundle comprises rows of tubes stacked such that tubes in adjacent rows are on a triangular pitch.

15. A tube support structure according to claim 14 wherein the spacing of the tubes is from 1.3 to 3 times the diameter of the tubes.

16. A tube support structure according to claim 1 wherein the tube bundle comprises rows of tubes stacked such that tubes in adjacent rows are on a square pitch.

17. A tube support structure according to claim 16 wherein the spacing of the tubes is from 1.15 to 3 times the diameter of the tubes.

18. A tube support structure according to claim 1 further comprising at least one retaining means substantially extending around the exterior of the tube bundle and interconnecting with the at least one brace means.

19. A tube support structure according to claim 18 wherein the at least one retaining means is a band extending around the bundle.

20. A tube support structure according to claim 19 wherein the band comprises a plurality of pieces.

21. A tube support structure according to claim 1 further comprising a support stave extending parallel to the tubes and connected to the or each retaining means, the or each bracing means or both the or each retaining means and the or each bracing means.

22. A tube support structure according to claim 1 wherein components of the support system are interconnected by welding.

23. A tube bundle comprising a plurality of tubes and a tube support structure according to claim 1.

24. A heat exchanger comprising a shell and at least one tube bundle according to claim 23.

25. A reactor comprising a shell and at least one tube bundle according to claim 23.

26. A reactor according to claim 25 wherein the reactor is a cross-flow reactor.

27. A reactor according to claim 25 additionally including a catalyst.

28. A kit of parts for forming the tube support structure of claim 1 optionally including instructions for assembly.
